(19) United States
(12) Patent Application Publication
(10) Pub. No.: US 2004/0128157 A1
(43) Pub. Date: Jul. 1, 2004

(54) Wager management service that allows individuals to make electronic wagers directly with other individuals

(75) Inventors: Frank J. Aquilino, Staten Island, NY (US); Frank T. Aquilino, Staten Island, NY (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Frank J. Aquilino

(21) Appl. No.: 10/690,461

(22) Filed: Oct. 21, 2003

Related U.S. Application Data
(60) Provisional application No. 60/420,478, filed on Oct. 21, 2002.

(51) Int. Cl. G06F 17/60

(52) U.S. Cl. 705/1

(57) ABSTRACT

A computer-implemented method of electronically placing wagers between a plurality of users includes a service provider hosting a database of wager offers and providing an electronic posting area for posting wager offers. A plurality of wager creators different than the service provider electronically communicate individual wager offers to the service provider's database of wager offers for storage therein. The wager offers include a wager condition, a wager payoff offer and a wager payoff request. The method also includes placing the individual wager offers in the posting area and allowing a plurality of wager acceptors to electronically communicate with the posting area to view and directly accept individually posted wager offers without incurring an individual wager service charge.

### CROSS-REFERENCE TO RELATED APPLICATIONS

This application claims the benefit of U.S. Provisional Application No. 60/420,478 filed Oct. 21, 2002 entitled “Wager Management Service That Allows Individuals To Wager Cash, Products Or Services On Sporting And Non-Sporting Events, And To Settle Disputed And Non-Disputed Results.”

### BACKGROUND OF THE INVENTION

1. Technical Field of the Invention

The present invention is a computer implemented business method and system whereby an independent service entity collects and processes wager information between individual people and settles disputed and non-disputed results.

The present invention includes the ability for participants to wager cash, products or services on sporting and non-sporting events. Through this service, participants may enter wager information including terms and event information into a globally accessible database that prospective participants may browse, query and potentially elect to wager against. The service also allows participants to communicate with each other regarding specific wagers.

The service may optionally include additional services related to assisting participants in the transaction process including, but not limited to, escrow services, payment transfer and processing services and general information services.

2. Background

Wagering in one form or another has been around since the earliest recorded time. The scope and methods have varied, but the essence has remained the same, two people with different opinions on the outcome of an upcoming event wager something on that outcome. After the event takes place, assuming both members agree on the outcome, the individual that was correct is compensated in accordance with the terms of the wager.

Traditionally, wagers are placed on specific public events that are determined by a bookmaker. The bookmaker creates a market for wagering on those pre-determined events and the bookmaker records the participant's wagers. After the event, the bookmaker determines and records the outcome of the event and pays the appropriate participants who wagered on that particular outcome.

In most cases, the bookmaker determines payoff ratios that vary depending on the ratio of participants betting on each potential outcome. In such a relationship, participants submit their wager to the bookmaker and their wager is not with any specific participant. As such, the bookmaker pools all proceeds and pays winning bets based upon a pre-set payoff ratio.

In a person-to-person arrangement, the bookmaker creates a market for wagers and matches participants with each other, and a wager is not valid unless another party is found to accept the terms of the wager. In this arrangement, the bookmaker collects the proceeds, pays the winner and deducts a fee for providing the service.

The objective of the present invention is to create a new type of wagering service in which the role of the traditional bookmaker is eliminated, and the participants themselves communicate directly with the database and with the other participants in creation of terms, markets and the settlement process.

### BRIEF SUMMARY OF THE INVENTION

In the present invention, the service is quite different from the traditional roles of a bookmaking service in that it does not participate in the creation of wagers, odds or terms, nor does it determine the results.

In the present invention, participants author their own wagers, including the event and any terms and conditions. Unlike traditional bookmaking services, this includes the ability to wager on any event, public or otherwise. For example, they may place a wager on a traditional public event such as an upcoming sporting event or the weather in a specific city on a specific day, or they may wager on something very specific and private such as the grade point average of their children's next report card.

In addition, the service allows the participants to determine payoff amounts and wager non-cash items such as merchandise and services. For example, a participant may elect to wager a Palm Pilot organizer that it will rain in New York on a specific date. When non-cash wagers are placed, the participant offering the non-cash item specifies the amount of cash they want in return should they win the wager.

Regardless of whether the event is public or private, the participants in each wager determine and record the outcomes of the event through a voting process. In cases where both participants do not agree on the outcome, the service includes facilities to settle the dispute.

The present invention comprises a computer-implemented method of electronically placing wagers between a plurality of users. A service provider hosts a database of wager offers and provides an electronic posting area for posting wager offers. A plurality of wager creators different than the service provider electronically communicate individual wager offers to the service provider's database of wager offers for storage therein. The wager offers include (i) a wager condition, (ii) a wager payoff offer and (iii) a wager payoff request. The method also includes placing the individual wager offers in the posting area and allowing a plurality of wager acceptors to electronically communicate with the posting area to view and directly accept individually posted wager offers without incurring an individual wager service charge.

The present invention also comprises a networked system for electronically placing wagers between a plurality of users including a website having web pages and a database of wager offers placed by some of the plurality of users. The website is configured to be accessed by a plurality of users and to permit users to offer wager offers directly to other users without incurring an individual wager service charge. The database includes (i) records of wager terms, (ii) records of users placing wager offers, (iii) records of users accepting wager offers and (iv) records of wager outcomes.

### BRIEF DESCRIPTION OF THE DRAWINGS

The above summary, as well as the following detailed description of a preferred embodiment of the invention, will be better understood when read in conjunction with the following drawings. For the purpose of illustrating the invention, the drawings show an example of how the invention may be implemented in a website. It should be understood that the invention is not limited to the precise arrangements and instrumentalities shown. In the drawings:

FIG. 1 shows an overall flow of main display screens in accordance with one preferred embodiment of the present invention;

FIG. 2 shows a flow of history and voting screens in accordance with one preferred embodiment of the present invention;

FIG. 3 shows an overview of the relationship between main betting tables in accordance with one preferred embodiment of the present invention;

FIGS. 4-10 show contents of the tables in accordance with one preferred embodiment of the present invention;

FIG. 11 is a screen shot of a home page for a website in accordance with the present invention;

FIG. 12 is a screen shot of a login page for a website in accordance with the present invention;

FIG. 13 is a screen shot of a signup page for a website in accordance with the present invention;

FIGS. 14-16 are screen shots of a “bet cash” page for a website in accordance with the present invention;

FIGS. 17-18 are screen shots of a “bet product” page for a website in accordance with the present invention.

FIG. 19 is a screen shot of a “bet history” page for a website in accordance with the present invention;

FIG. 20 is a screen shot of an existing wager page for a website in accordance with the present invention;

FIG. 21 is a screen shot of a vote on outcome of a wager page for a website in accordance with the present invention;

FIG. 22 is a screen shot of a status page for a website in accordance with the present invention;

FIG. 23 is a screen shot of an accept/decline page for a website in accordance with the present invention;

FIG. 24 is a screen shot of an acceptance comment page for a website in accordance with the present invention;

FIG. 25 is a screen shot of a wager offer withdrawal page for a website in accordance with the present invention;

FIG. 26 is a screen shot demonstrating that a wager offer cannot be accepted once withdrawn for a website in accordance with the present invention;

FIG. 27 is a screen shot of a wager offer acceptance status page for a website in accordance with the present invention;

FIG. 28 is a screen shot of a voting page for a wager creator for a website in accordance with the present invention;

FIG. 29 is a screen shot of a dispute voting page for a wager creator and a wager acceptor for a website in accordance with the present invention;

FIG. 30 is a screen shot of a dispute voting page for other users for a website in accordance with the present invention; and

FIGS. 31-33 are screen shots for feedback pages for a website in accordance with the present invention.

### DETAILED DESCRIPTION OF THE INVENTION

Certain terminology is used herein for convenience only and is not to be taken as a limitation on the present invention. The word “a” is used in the claims and in the corresponding portions of the Specification, means “at least one.” Furthermore, the terms “wager” and “bet,” and derivatives thereof, are used interchangeably throughout the Specification and the claims and should not be construed as limiting.

1. Overview of the Flow of the Present Invention

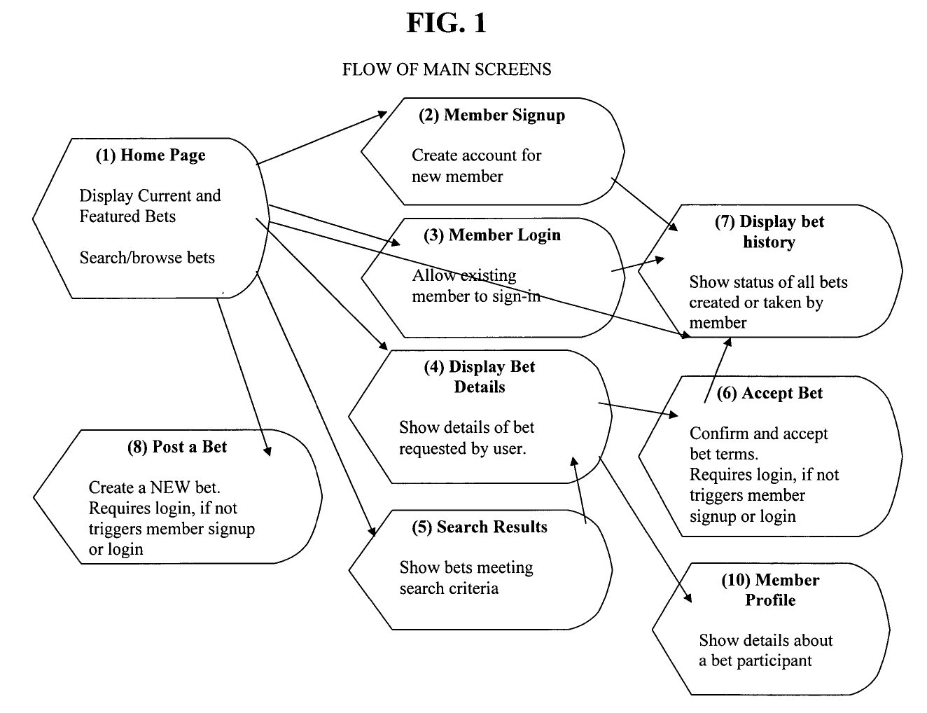

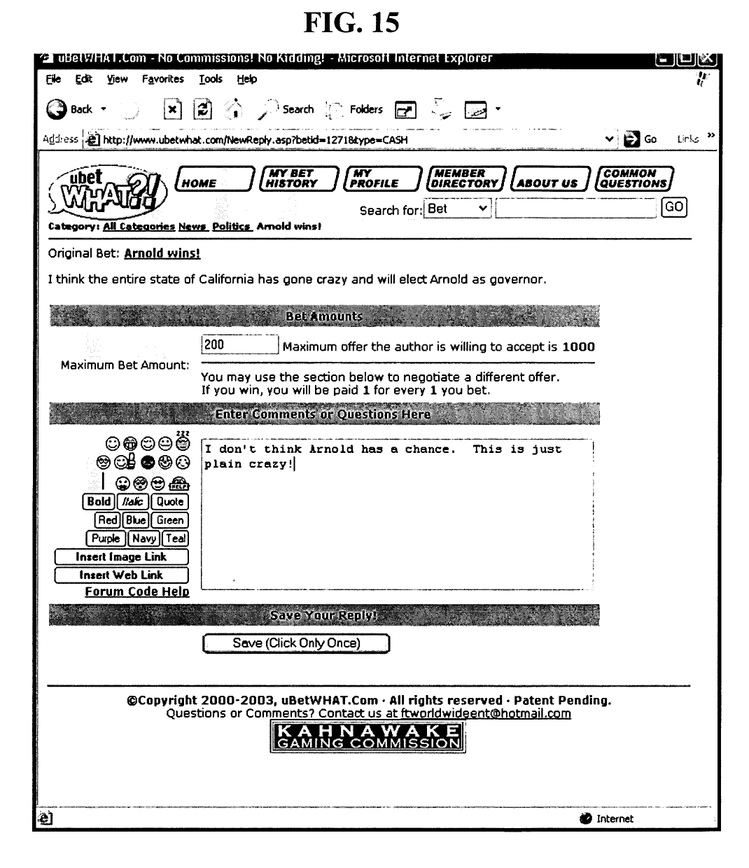

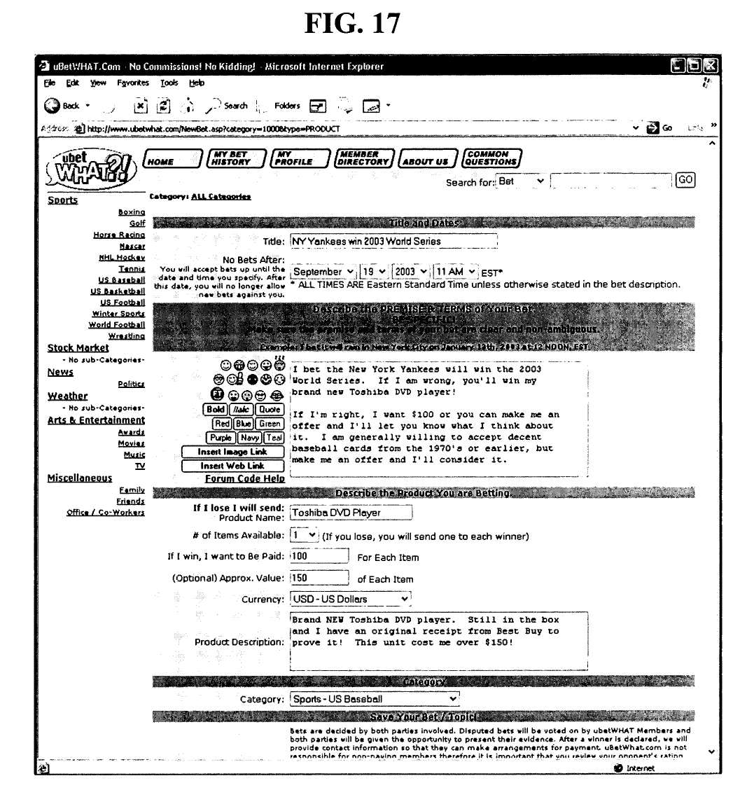

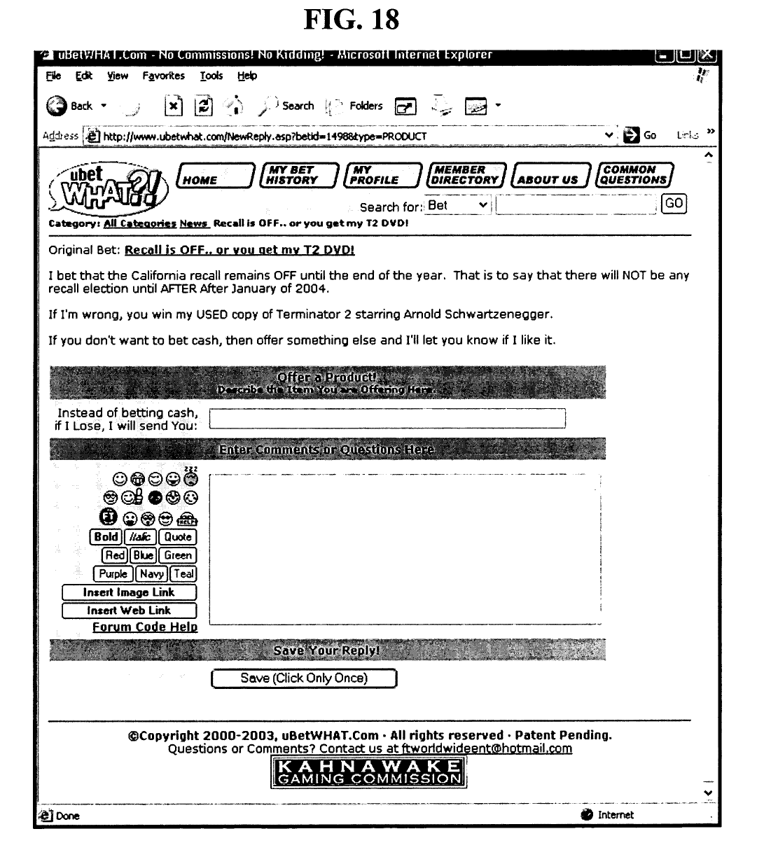

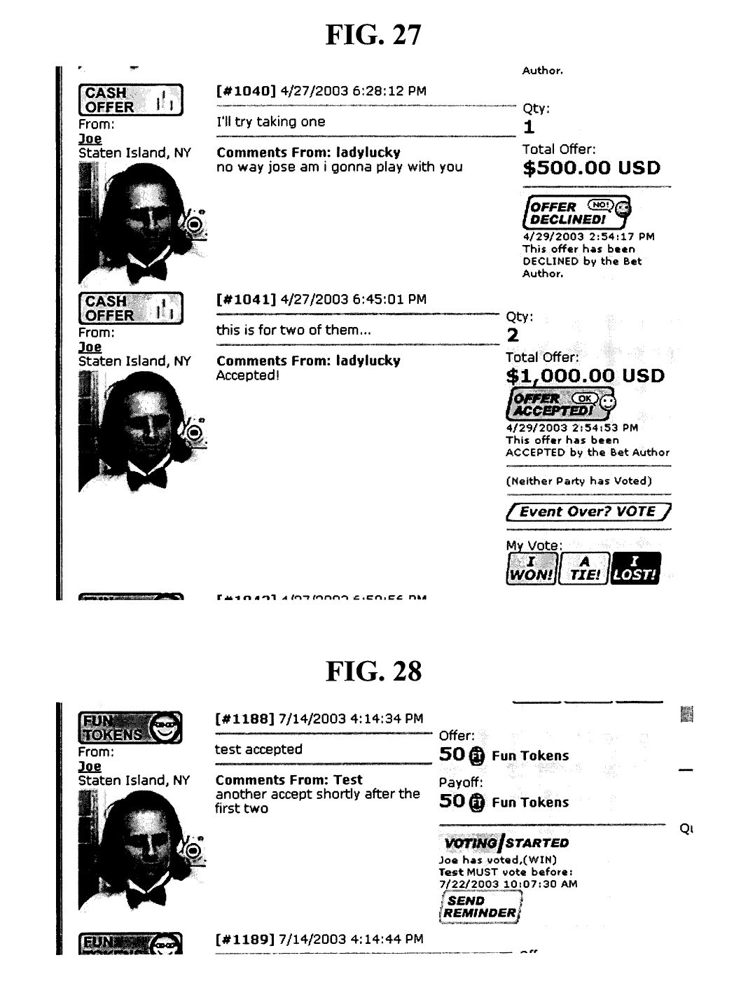

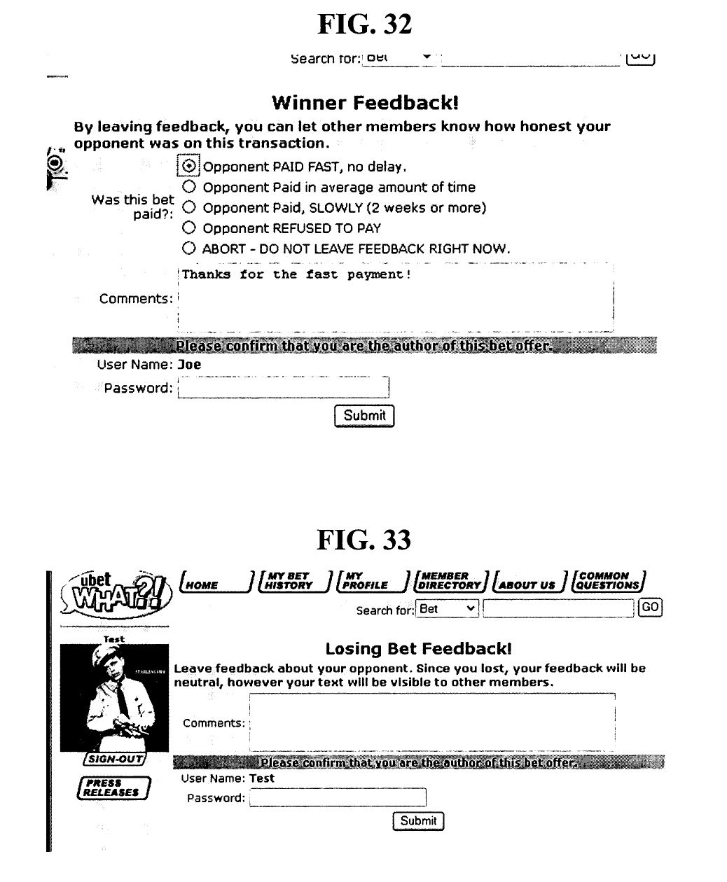

Referring to FIGS. 1-33 in detail, the method and apparatus of the present invention will now be discussed including references and explanations of the individual components of the invention.

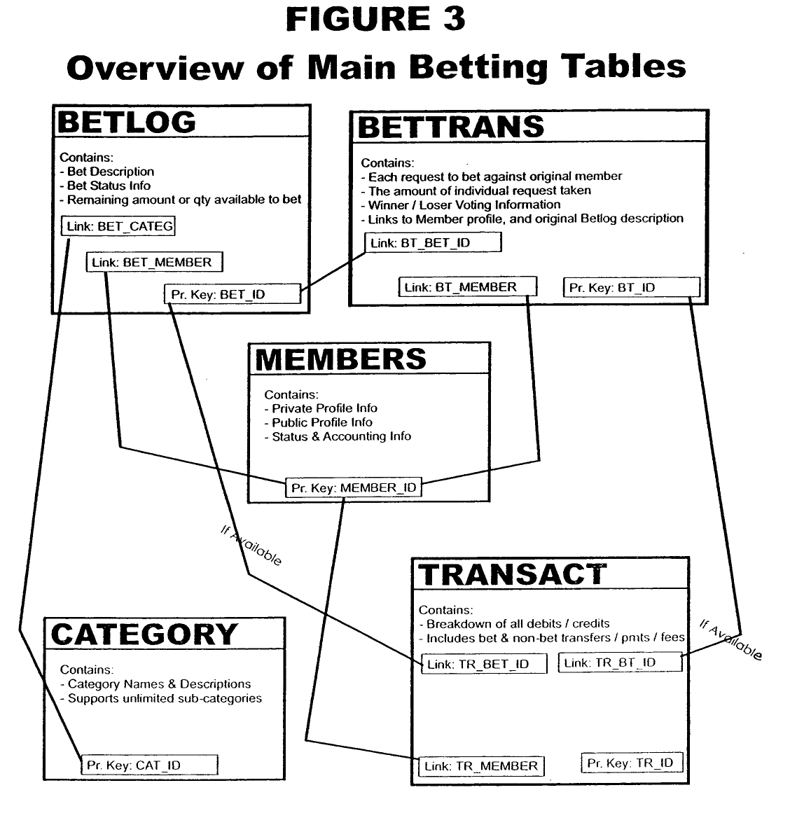

At the core of the invention is a database of wager offers/acceptances, also referred to as a “bet database” (FIGS. 3-10), which is accessible via a network such as a global network including the Internet (see for example FIGS. 1-2 and 11-33).

Both members or users and non-members (i.e., visitors) are free to browse or search bet database for a bet or wager offer that interests them, however to place or author a bet, the user must sign in as a member. Visitors may include anyone who is not currently logged in to the service regardless of their membership status, but more commonly visitors encompasses non-members only.

A membership application is submitted and the member is assigned a unique identification.

Members may log in at any time using their unique identification and a user-defined password.

Wager offers/wager acceptances (i.e., bets) can be for cash, products, services, points and the like and/or combinations thereof. If the bet is for a product, the wager creator determines the amount the wager creator would like in return for each product if the wager creator wins which establishes a wager request.

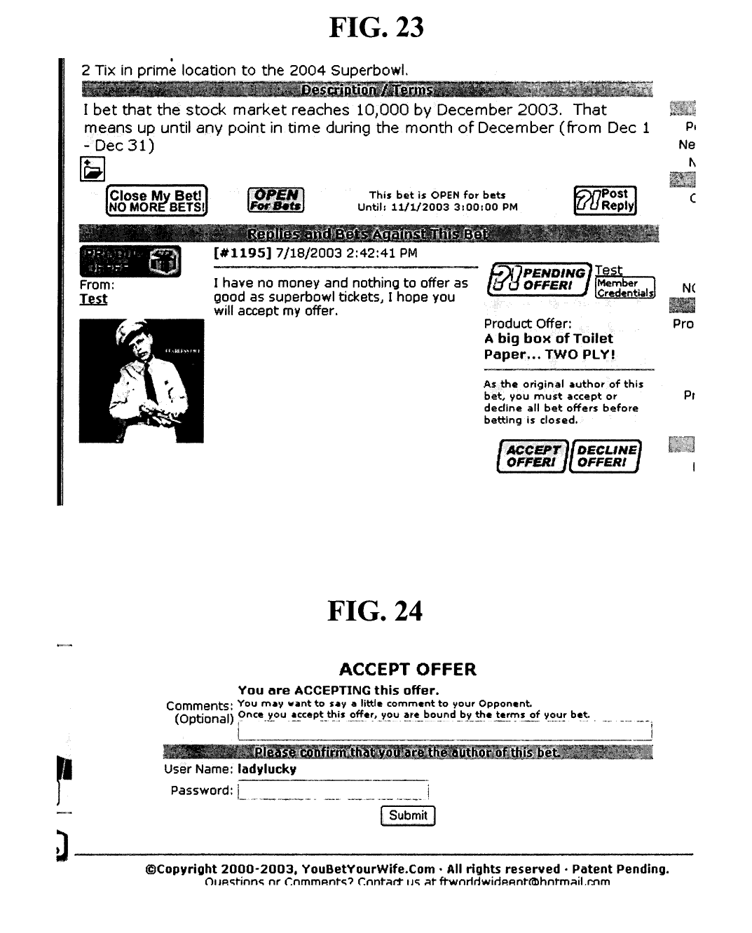

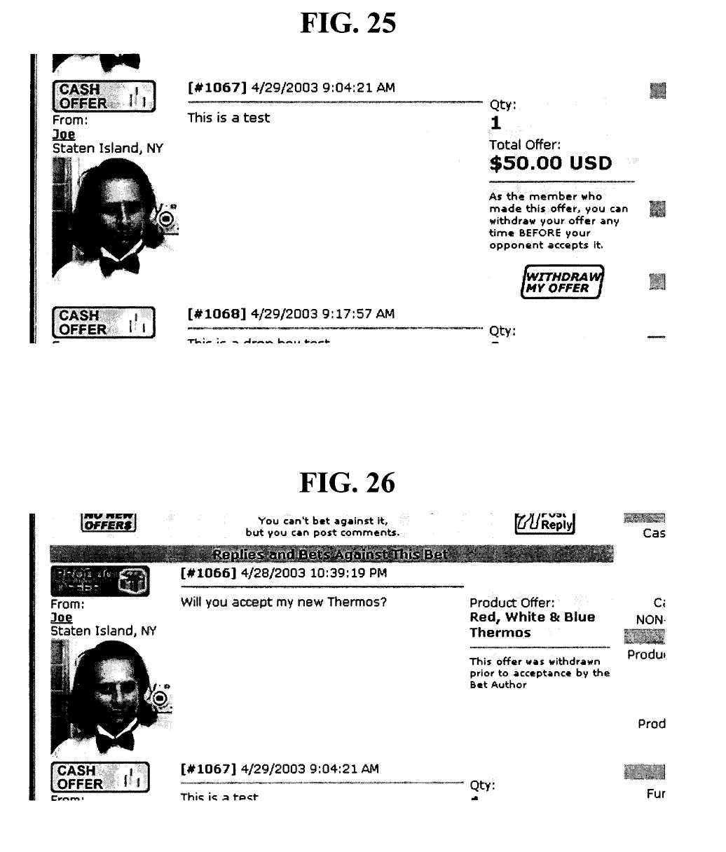

Wager offers are listed in the database of wager offers for a fixed length of time as determined by the wager creator. During that time, other members or users can bet against the initial wager offer by accepting wager offers thereby becoming wager acceptors (FIGS. 23-26). For example, when the wager creator makes a wager offer, the wager offer preferably has terms including for example (i) a wager condition having a determinative outcome, (ii) a wager payoff offer, (iii) a wager payoff request, (iv) a start date, and (v) a close date. The wager condition is based on a determinative outcome such as a sporting event, a public election, a public event, an entertainment award, the weather at a predetermined time and location, a financial indicator value at a particular time and day, and a specific user defined event. The wager payoff offer may be money, products (FIG. 26), services and points (FIG. 28). Similarly, the wager payoff request may be money (FIG. 25), products, services and points, but the wager payoff offer may be the same or different than the wager payoff request. Thus, the system can account for differences in the “odds” of a particular wager condition. The wager acceptor can also make a comment when accepting the wager offer and the terms associated therewith as shown in FIG. 24.

When a bet or wager offer is placed, the wager creator determines the amount the wager creator is willing to bet (i.e., the wager payoff offer) and the amount the wager creator wants in return from a wager acceptor if the wager creator wins (i.e., the wager payoff request). It should be apparent that wager creators and wager acceptors are a subset of the overall set of members or users. In some instances, a user is a wager creator for a particular wager offer (bet) and in other instances that same user may be a wager acceptor for another, different wager offer (bet). In other instances, that user does not participate in a particular wager offer at all.

Once betting is closed, the bet remains in the database of wager offers until the settlement date or until one of the original members votes on the outcome. The settlement date may be the same as or different than the close date for a particular wager offer. Thus, a particular wager offer may have a close date that is prior to a settlement date or the date/time of a particular wager condition if the wager creator so desires.

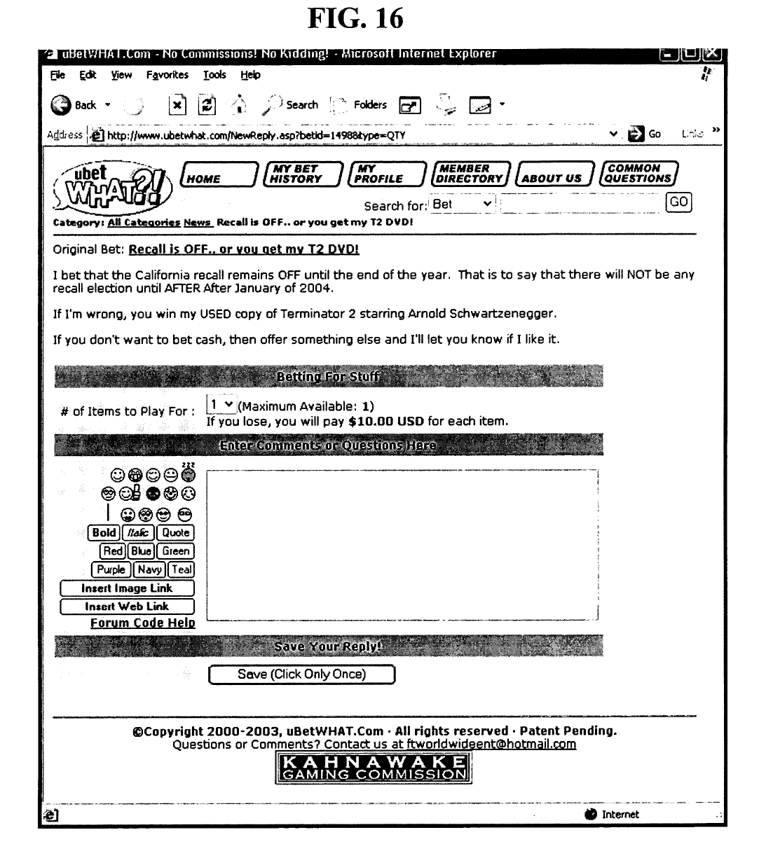

After a vote is placed, the wager acceptor is given 7 days to vote or their vote will be assumed to agree with the wager creator (FIG. 28). If both members agree, the winner is declared and e-mail is sent to both members so that they can settle the bet. Once the bet is settled, both members have up to 90 days to post feedback about the transaction (FIGS. 31-33). Honest members are rewarded for their payment with positive feedback, and negative members would be penalized. The feedback system is provides members a way to determine the honesty of the member they are betting or wagering against. FIGS. 31-33 show the feedback process for both winning and losing bets. Before placing a bet, the member can view the feedback history to determine the potential risk involved in accepting a bet from the other party and vice versa. See for example, a “bet history page” as depicted in FIG. 16 which shows disputed bets, bets lost and bets won for a particular member.

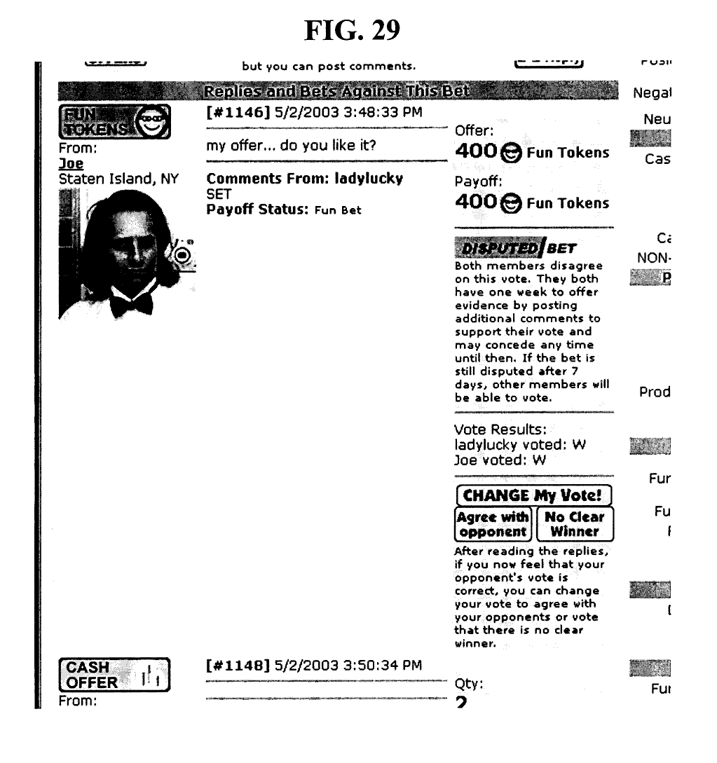

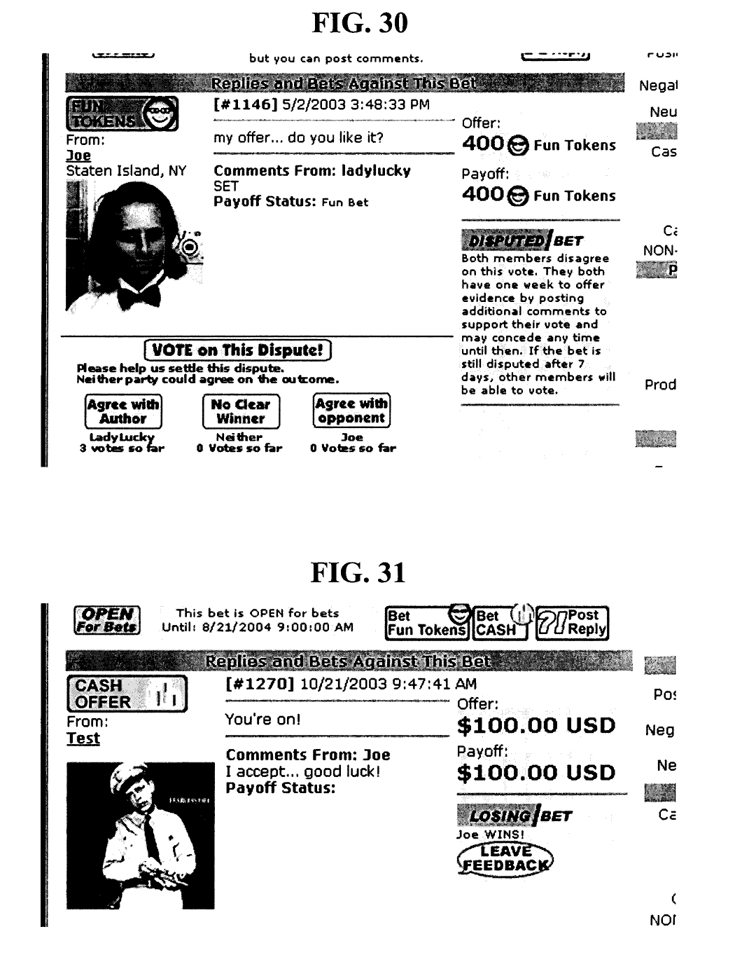

If a bet or wager is disputed, both members are given 7 days to post comments including their own evidence as to why they feel they won (FIG. 29). After the 7th day, if they still disagree, the bet moves to a “Disputed Bets Page” (FIG. 30), where other members are given a chance to vote on the winner. Disputed bets must be settled by a 75% vote from a minimum of 25 members within a 90-day period. If 25 members do not vote within that period of time, the bet is declared a tie.

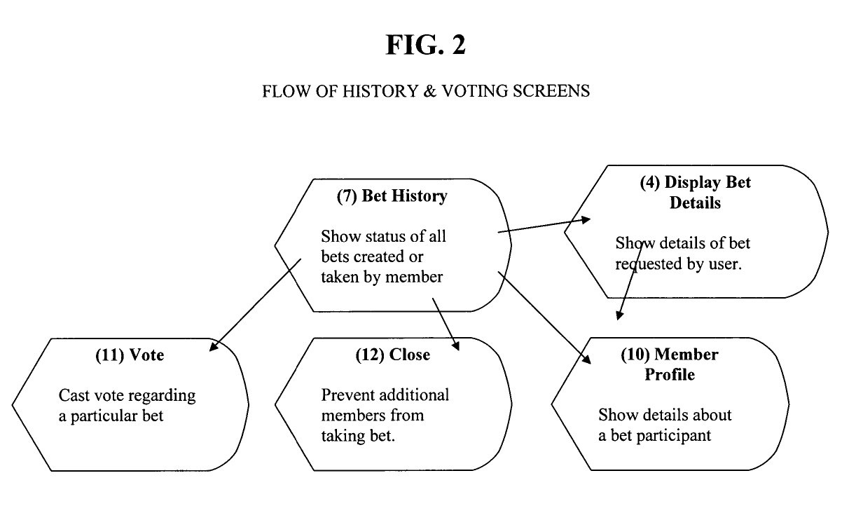

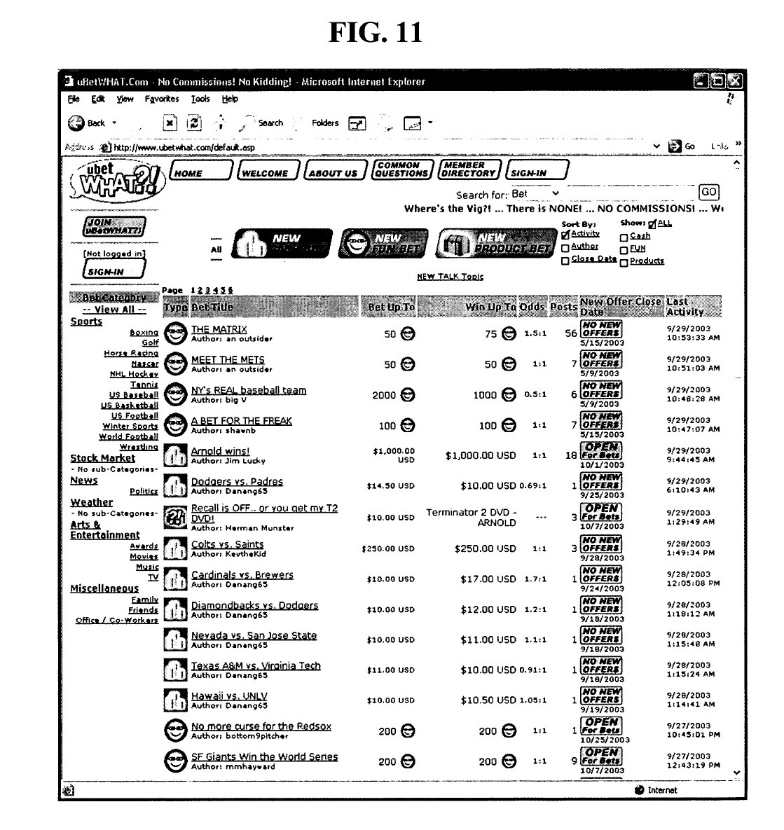

FIG. 1 shows an overall flow of main display screens. FIG. 2 shows a flow of history and voting screens. Referring to FIGS. 1 and 2 and the sample screens (i.e., pages for a website) depicted in FIGS. 11-33, the screen flow summary is as follows:

(1) The home page (FIG. 11) is displayed showing a random sampling of existing bets. The home page provides a link for existing members to login, a link for visitors to signup to become a member, a search field for searching the database of wager offers, the ability to modify how the search field searches, a listing of the most active categories of wager offers and a display of a randomly selected feature wager offer.

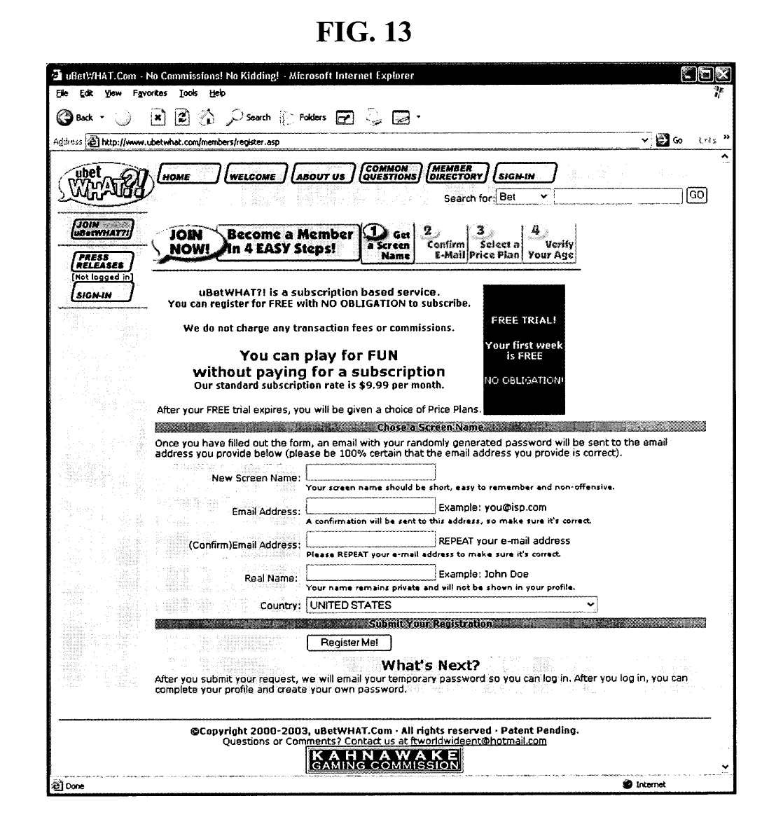

(2) If a visitor wishes to become a member, the visitor may sign up and become a member or user using a signup page (FIG. 13).

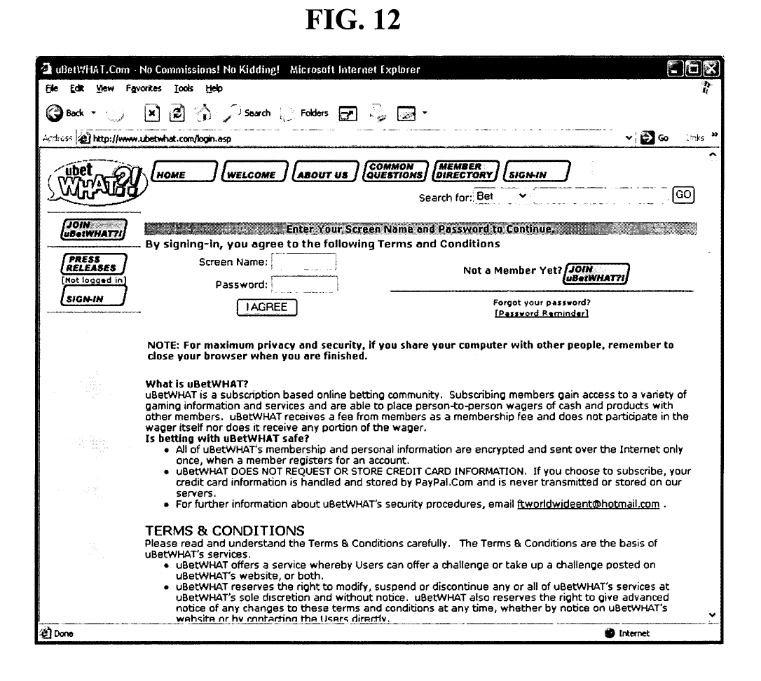

(3) If the visitor is already a member or user, the existing user may login using a login screen (FIG. 12).

(4) Regardless of membership, the visitor may request additional information about a bet or wager offer displayed on the current page by viewing a “bet detail” screen such as the one shown in FIG. 16.

(5) At any time, the visitor may search the database of bets to find a bet in which they would like to participate.

(6) If a user requests the option to accept a displayed bet, the user is given a screen to confirm the terms. But, if the user is not logged in, the user will be given the opportunity to either create an account (FIG. 13) or to log in using their existing account (FIG. 12).

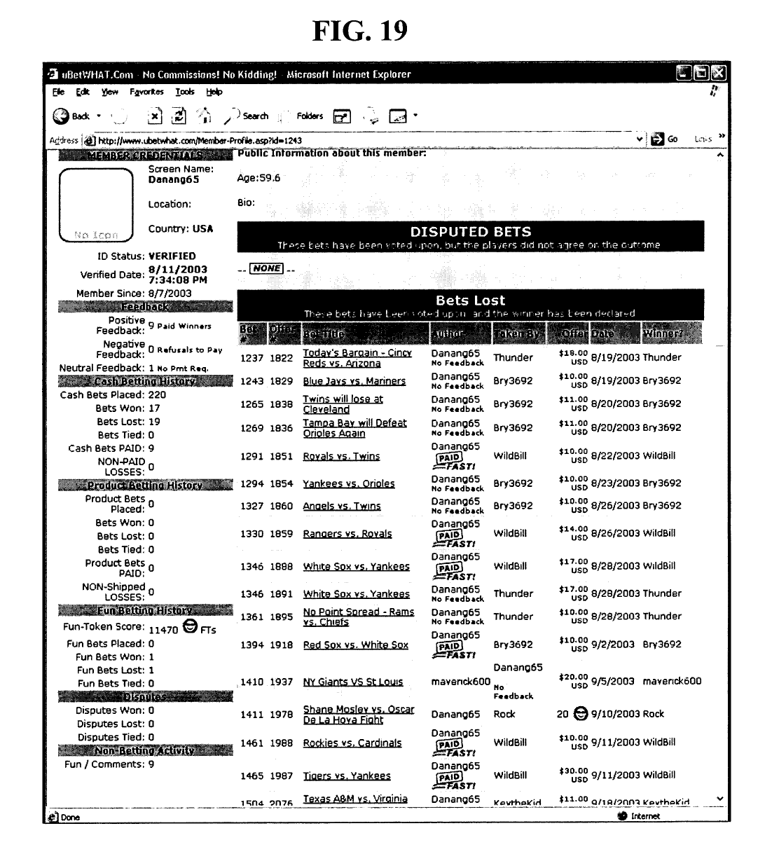

(7) After logging in, posting a new bet, or accepting an existing bet, the user is directed to a screen displaying a history of all their bets, including the status of any pending bets (e.g., FIG. 19).

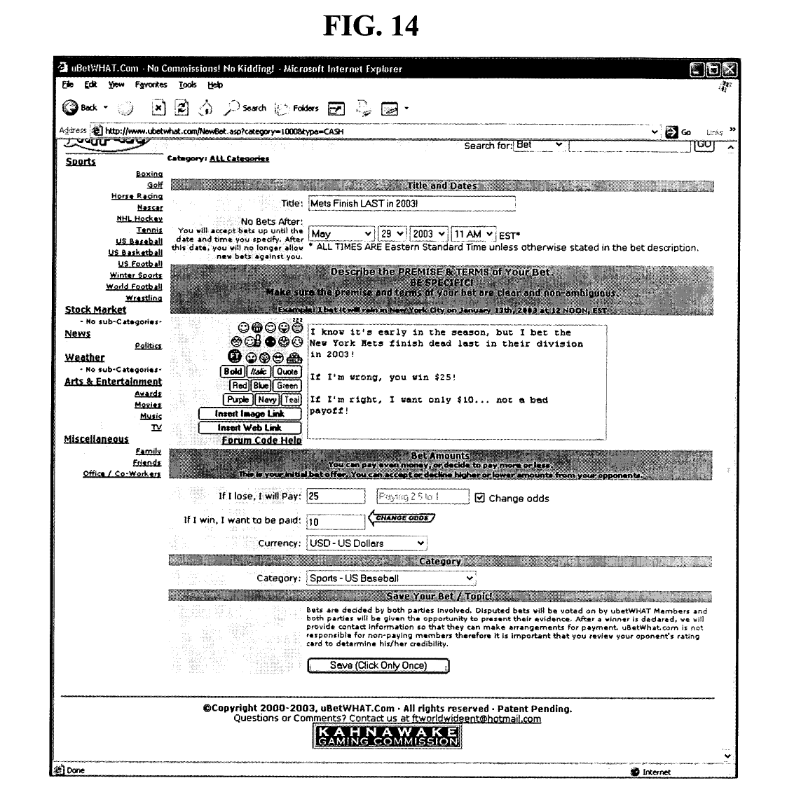

(8) If the user wishes to create a new bet or wager offer, the user is directed to a screen to enter the terms of the bet or wager offer (FIGS. 14-18). If the user is not logged in, the user is given the opportunity to either create an account (FIG. 13) or log in using their existing account (FIG. 12).

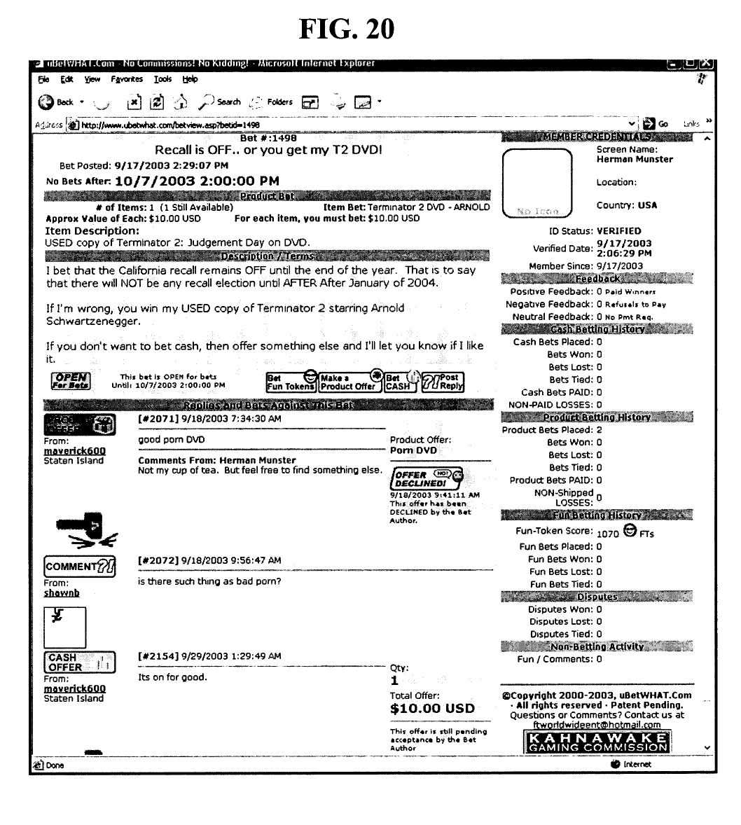

(9) Each existing wager offer displays the information the member entered in main screen (FIG. 11), and using FIGS. 14-18, allowing them to confirm or abort using a “bet detail” screen (FIG. 20).

(10) The “bet detail” screen (FIG. 20) displays the profile of the wager creator for a particular wager offer, including the wager creator's betting statistics.

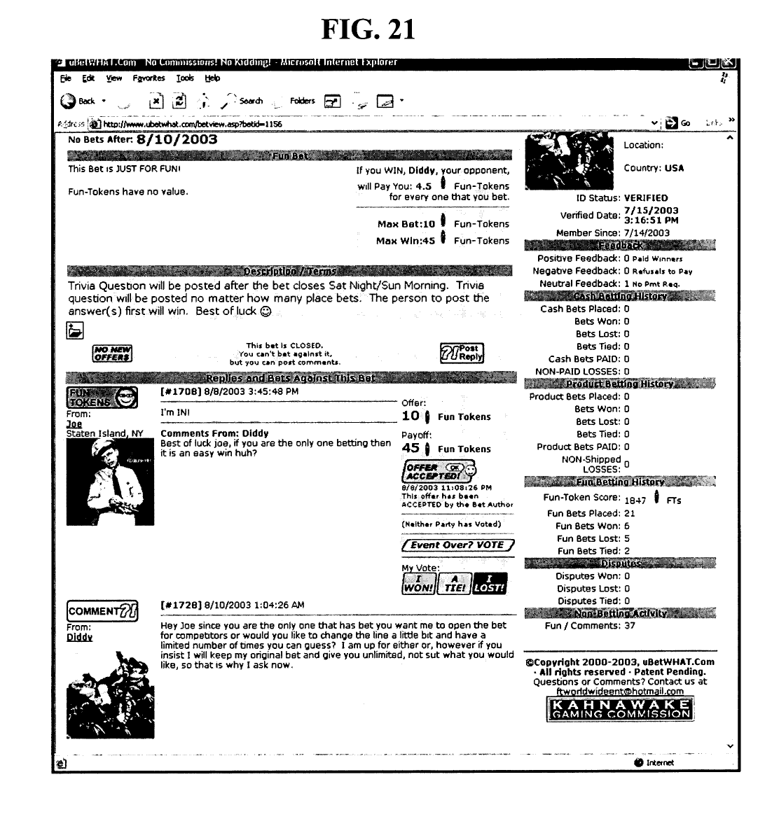

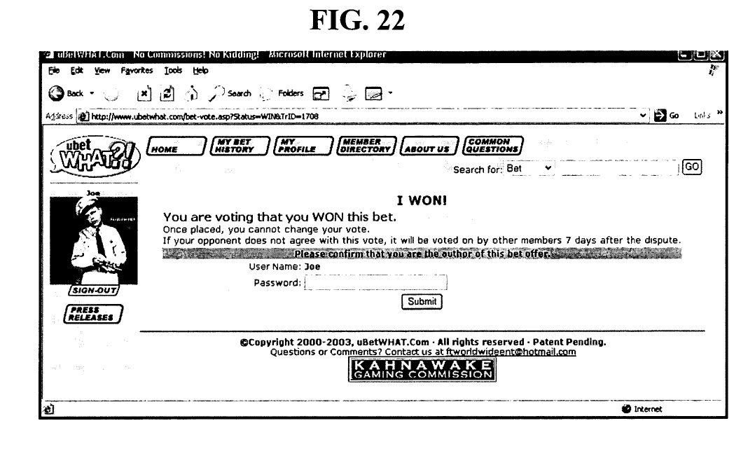

(11) A vote on outcome of a wager offer screen (FIG. 21) allows the wager creator to cast their vote on the wager offer they have made. A wager creator may vote “Win,” “Loss” or “No winner” (FIGS. 21-22).

(12) This screen allows the member to remove the bet from the listings and stop additional members from taking the bet (See FIG. 2). Existing bets against that particular bet remain in effect until voting.

2. Database Relationships

The following are the main databases used in the system and a description of their relationships.

FIG. 3 is a graphic overview of the relationships between the core tables in one preferred embodiment of the present invention.

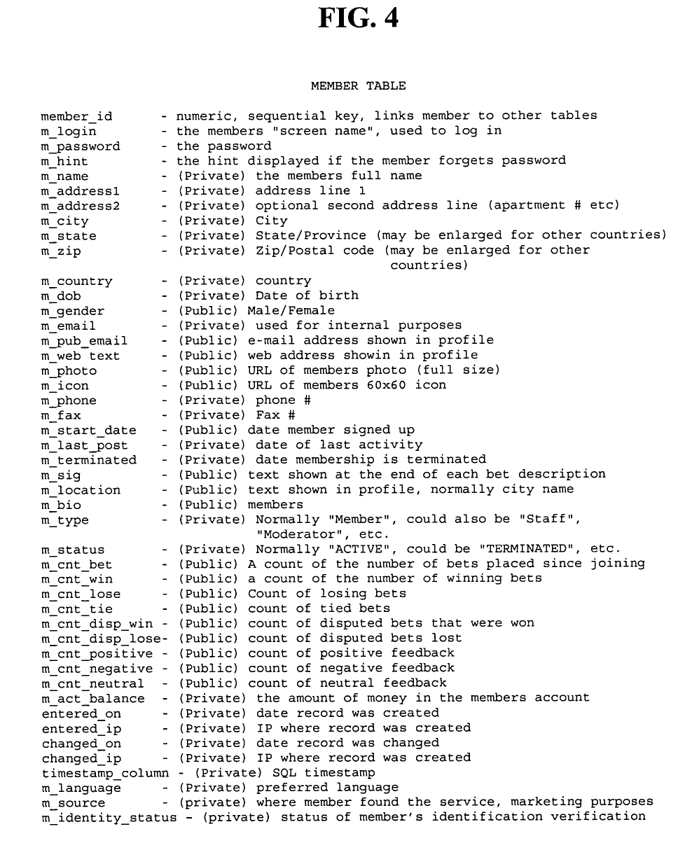

FIG. 4 is the “MEMBERS TABLE.” The Members table stores all private and public account information for all registered members. A new record is created for each new member that signs up. Each member has a unique identification which is used to reference the member in other tables.

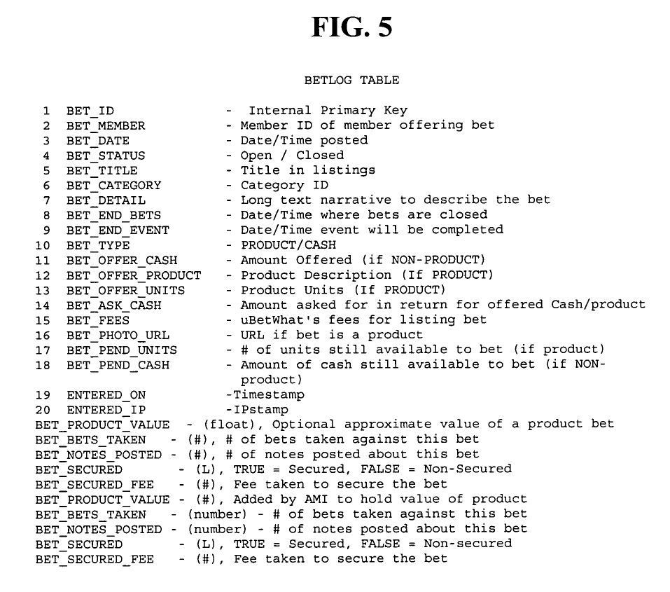

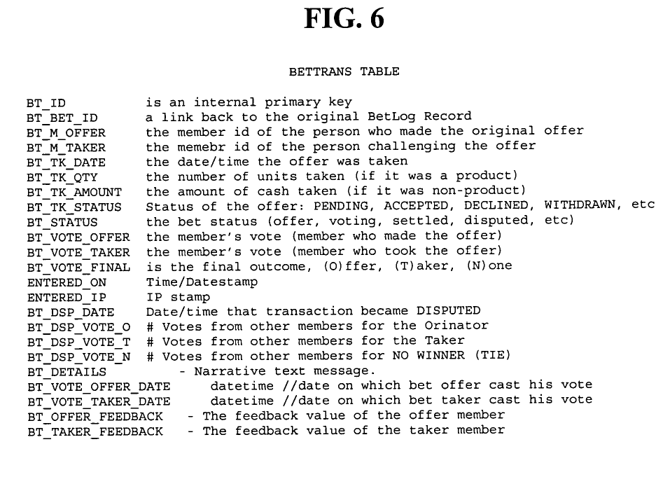

FIG. 5 is the “BETLOG TABLE.” The Betlog or wager log table is the primary table for all bets created in the system. With each new bet authored by a member, a new record is created in the Betlog table. The record contains all of the terms for the bet as well as a reference to the author of the bet. Each bet in the Betlog table has a reference id which is used to track any transactions related to that bet in other tables. This table holds the original summary bet information for each individual bet, bets against these bets are stored in the Bet Transaction table (Bettrans, FIG. 6).

FIG. 6 is the “BETTRANS TABLE.” The bettrans or wager transactions table contains records related to specific transactions related to the bets in the Betlog table. For example, if a member creates a new bet for $1000, there would be a single record in the Betlog table, but there could be a large number of records in the Bettrans table, one for each opposing bet from other members.

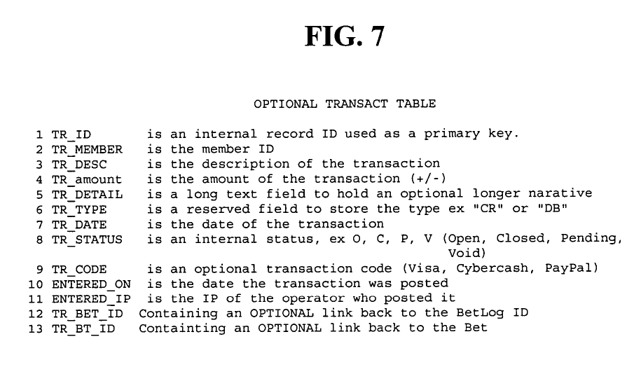

FIG. 7 is the “TRANSACT TABLE.” This optional table includes any financial transactions related to a member's account. These transactions could include deposits for membership dues, transaction or escrow fees. This table could also potentially hold information regarding the mutual holding of funds for both parties in a bet, whereby the declared winner would be paid directly from the fund upon verification of the winning bet.

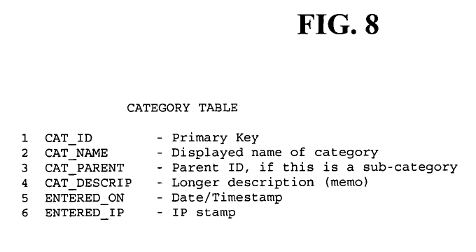

FIG. 8 is the “CATEGORY TABLE.” This table is used to categorize all bets entered into the system so that members may browse bets by category rather than by searching. By using the “CAT_PARENT” field, a category can be posted with the category ID of another category, thereby creating sub-categories.

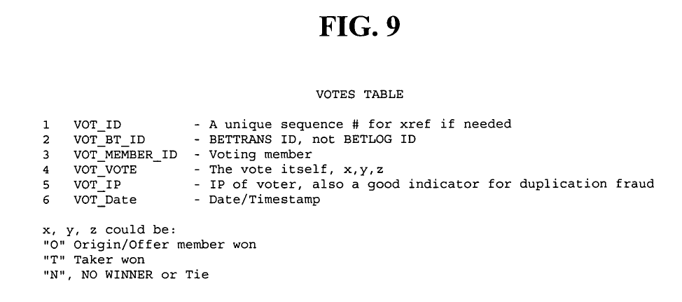

FIG. 9 is the “VOTES TABLE.” When there is a disputed bet outcome, both parties are offered 7 days to come to an agreement. If no agreement can be reached, other members are allowed to vote on the winner. These votes are recorded in the Votes Table. A reference is made to the original bet transaction (bettrans). Neither of the members involved in the original bet is permitted to vote here.

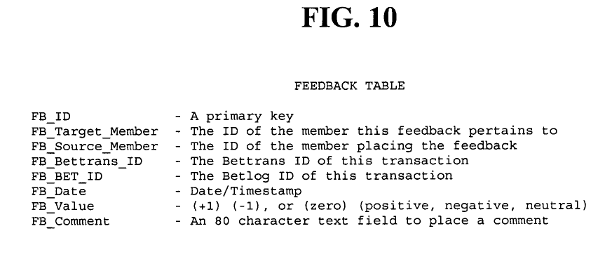

FIG. 10 is the “FEEDBACK Table.” After a bet is settled, both members are given an opportunity to offer feedback regarding the other party in the transaction. Assuming both parties were fair and honest, they would both offer positive feedback. Negative feedback serves to warn members of the potential that they may be taking a risk by betting against the other member.

3. Example of a Working Transaction

1. Member “SAM” creates a membership account:

a. A record is created in the MEMBERS table with the Member ID being set to “SAM”.

b. Various other demographic fields are entered, and stored in the same record.

2. “SAM” creates a new bet:

a. A record is created in the BETLOG table with the details of the bet.

| | |
|---|---|
| BET_ID | 1234 |
| BET_MEMBER | “SAM” |
| BET_DATE | 07/15/2001 |
| BET_STATUS | “OPEN” |
| BET_TITLE | “I bet it will rain in NY on Tuesday” |
| BET_CATEGORY | “WEATHER” |
| BET_DETAIL | “I bet it will rain in New York City on |
| | Tuesday the 7 . . . ” |
| BET_END_BETS | “07/25/2001” |
| BET_END_EVENT | “08/08/2001” |
| BET_TYPE | “CASH” |
| BET_OFFER_CASH | $500 |
| BET_OFFER_PRODUCT | “” |
| BET_OFFER_UNITS | “” |
| BET_ASK_CASH | $100 |
| BET_FEES | N/A in this version |
| BET_PHOTO_URL | “” |
| BET_PEND_UNITS | “” |
| BET_PEND_CASH | $100 |
| ENTERED_ON | 07/15/2001 12:05 |
| ENTERED_IP | 123.123.123.123 |
| BET_PRODUCT_VALUE | |
| BET_BETS_TAKEN | 0 |
| BET_NOTES_POSTED | 0 |
| BET_SECURED | FASLE |
| BET_SECURED_FEE | 0 |
| BET_PRODUCT_VALUE | 0 |
| BET_BETS_TAKEN | 0 |
| BET_NOTES_POSTED | 0 |

3. “DAVE” browses bets in the “WEATHER” category:

a. All records in the Betlog table are shown which contain “WEATHER” in the BET_CATEGORY field, including SAM's bet.

b. He could also have located that particular bet by searching for “weather”, “NY”, “Rain” or any other words listed in the Betlog record.

4. DAVE bets $10 against SAM:

a. The BETLOG record is changed:

i. BET_PEND_CASH is reduced from $100 to $90

ii. BET_BETS_TAKEN is increased from 0 to 1

b. A new BETTRANS record is created:

| | |
|---|---|
| BT_ID | 13526 |
| BT_BET_ID | 1234 |
| BT_M_OFFER | SAM |
| BT_M_TAKER | DAVE |
| BT_TK_DATE | 07/17/2001 |
| BT_TK_UNITS | 0 |
| BT_TK_CASH | $10 |
| BT_STATUS | “OPEN” |
| BT_VOTE_OFFER | |
| BT_VOTE_TAKER | |
| BT_VOTE_FINAL | |
| ENTERED_ON | 07/17/2001 |
| ENTERED_IP | 121.121.121.121 |
| BT_DSP_DATE | |
| BT_DSP_VOTE_O | 0 |
| BT_DSP_VOTE_T | |
| BT_DSP_VOTE_N | |
| BT_TRACKING_NUMBER | |
| BT_DETAILS | |
| BT_CARRIER_NAME | |
| BT_SHIPPED_DATE | |
| BT_TAKER_SHIP_CONF | |
| BT_TAKER_CONF_DATE | |
| BT_VOTE_OFFER_DATE | |
| BT_VOTE_TAKER_DATE | |
| BT_OFFER_FEEDBACK | |
| BT_TAKER_FEEDBACK | |

5. BOB bets $90 against SAM:

a. The BETLOG record is changed:

i. BET_PEND_CASH is reduced from $90 to $0

ii. BET_BETS_TAKEN is increased from 1 to 2

iii. BET_STATUS is changed from “OPEN” to “CLOSED” (because there is no longer any money left to bet against)

b. A new BETTRANS record is created:

| | |
|---|---|
| BT_ID | 13527 |
| BT_BET_ID | 1234 |
| BT_M_OFFER | SAM |
| BT_M_TAKER | BOB |
| BT_TK_DATE | 07/18/2001 |
| BT_TK_UNITS | 0 |
| BT_TK_CASH | $90 |
| BT_STATUS | “OPEN” |
| BT_VOTE_OFFER | |
| BT_VOTE_TAKER | |
| BT_VOTE_FINAL | |
| ENTERED_ON | 07/18/2001 |
| ENTERED_IP | 121.121.121.121 |
| BT_DSP_DATE | |
| BT_DSP_VOTE_O | 0 |
| BT_DSP_VOTE_T | |
| BT_DSP_VOTE_N | |
| BT_TRACKING_NUMBER | |
| BT_DETAILS | |
| BT_CARRIER_NAME | |
| BT_SHIPPED_DATE | |
| BT_TAKER_SHIP_CONF | |
| BT_TAKER_CONF_DATE | |
| BT_VOTE_OFFER_DATE | |
| BT_VOTE_TAKER_DATE | |
| BT_OFFER_FEEDBACK | |
| BT_TAKER_FEEDBACK | |

6. It Rains in NY on the date mentioned in the bet (SAM was correct).

a. SAM votes “I WON” for both bets against him

i. BT_VOTE_OFFER is changed to “W” in both Bettrans records (#13526 & 13527)

ii. BT_STATUS is changed from OPEN to “PENDING” in both Bettrans records (# 13526 & 13527), for 7 days or until the other parties vote, whichever comes first.

7. BOB agrees and acknowledges that SAM won.

a. BOB votes “I LOST”

i. BT_VOTE_TAKER is changed to “L” in Bettrans # 13527

ii. BT_STATUS is changed to “SETTLED” in Bettrans # 13527

8. DAVE disagrees with SAM, and says that he won too.

a. DAVE votes “I WON”

i. BT_VOTE_TAKER is changed to “W” in Bettrans # 13526

ii. BT_STATUS is changed to “DISPUTED” in Bettrans # 13526

b. Since the bet is now in dispute, neither party is considered the winner.

c. Both parties have up to 7 days to communicate the reasons they feel they won, to offer proof and to re-consider their votes.

d. After the 7 days, if they still do not agree, the bet will be made available for voting by other members.

9. Third party settlement for SAM & DAVE's bet.

a. 7 Days after a dispute, the bet is placed on the Disputed Bets pool, where other members are free to participate in the voting process.

The present invention is described in the context of a service available from a web site, www.uBetwhat.com. The present invention is described in the context of a plurality of distributed computers that allow users to connect to the database via an electronic network, such as the Internet, or any other communication media. Thus, the present invention is in one aspect a networked system for electronically placing wagers between a plurality of users including a website having web pages and a database of wager offers placed by some of the plurality of users. The website is configured to be accessed by a plurality of users and to permit users to offer wager offers directly to other users without incurring an individual wager service charge. The database includes (i) records of wager terms, (ii) records of users placing wager offers, (iii) records of users accepting wager offers and (iv) records of wager outcomes. However, the scope of the present invention is not limited to these particular implementations of the invention.

The present invention may be implemented with any combination of hardware and software. If implemented as a computer-implemented apparatus, the present invention is implemented using means for performing all of the steps and functions described above. Thus, the present invention is, in another aspect, a computer-implemented method of electronically placing wagers between a plurality of users includes a service provider hosting a database of wager offers and providing an electronic posting area for posting wager offers. A plurality of wager creators different than the service provider electronically communicate individual wager offers to the service provider's database of wager offers for storage therein. The wager offers include (i) a wager condition, (ii) a wager payoff offer and (iii) a wager payoff request. The method also includes placing the individual wager offers in the posting area and allowing a plurality of wager acceptors to electronically communicate with the posting area to view and directly accept individually posted wager offers without incurring an individual wager service charge.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A computer-implemented method of electronically placing wagers between a plurality of users comprising:
a) a service provider hosting a database of wager offers, the service provider providing an electronic posting area for posting wager offers;
b) a plurality of wager creators different than the service provider electronically communicating individual wager offers to the service provider's database of wager offers for storage therein, the wager offers including:
(i) a wager condition,
(ii) a wager payoff offer, and
(iii) a wager payoff request;
c) placing the individual wager offers in the posting area; and
d) allowing a plurality of wager acceptors to electronically communicate with the posting area to view and directly accept individually posted wager offers without incurring an individual wager service charge.

2. The method of claim 1, further comprising:
e) allowing a visitor, who is not a user, to request additional information about a wager that is displayed on the posting area regardless of a membership status of the visitor.

3. The method of claim 2, further comprising:
f) allowing the visitor, at any time, to search the database of wager offers in order to find a wager offer in which the visitor is interested in participating.

4. The method of claim 2, further comprising:
f) allowing a visitor to become a user by creating a user account.

5. The method of claim 1, further comprising:
e) allowing a user to login if the user has a user account.

6. The method of claim 5, further comprising:
f) allowing the user, after logging in, to create a new wager or accept an existing wager offer.

7. The method of claim 5, further comprising:
f) bringing the user to a screen displaying a history of the user's wager offers, including a status of any pending wager offers, immediately after the user logs in.

8. The method of claim 1, wherein an individual wager acceptor is prompted to confirm and accept terms of a particular wager offer when individual wager acceptor requests to accept the particular wager offer.

9. The method of claim 8, wherein if the individual wager acceptor is not logged in, the individual wager acceptor will be prompted to create a new user account or to log in using an existing user account.

10. The method of claim 1, wherein, when an individual wager creator desires to create a new wager offer, the individual wager creator is prompted to enter terms of the new wager offer.

11. The method of claim 10, wherein if the individual wager creator is not logged in, the individual wager creator will be prompted to create a new user account or to log in using an existing user account.

12. The method of claim 1, further comprising:
e) displaying public profile information about each user that each individual user entered when setting up or editing a respective individual user account.

13. The method of claim 1, further comprising:
e) allowing an individual wager acceptor to confirm or abort the acceptance of a wager offer in step d).

14. The method of claim 1, further comprising:
e) displaying public profile information of a particular user upon request, and displaying that particular user's wagering statistics including wins, losses, and disputed wager offers.

15. The method of claim 1, further comprising:
e) allowing an individual wager creator to electronically cast a vote in the posting area about a particular wager offer created by the individual wager creator, the vote including one of “win,” “loss” or “no winner.”

16. The method of claim 1, further comprising:
e) allowing an individual wager creator to remove a particular wager offer created by the individual wager creator thereby stopping additional individual wager acceptors from accepting the particular wager offer.

17. The method of claim 1, wherein each user has a unique identification from each other user.

18. The method of claim 1, further comprising:
e) a database of user accounts including a unique identification record for each registered user that is utilized by other records and databases to identify each particular user.

19. The method of claim 1, wherein the database of wager offers includes:
i) a wager log table for all wager offers, the wager log table having a record of each wager being authored by a unique wager creator including terms of the wager offer; and
ii) a wager transaction table containing records of specific acceptance transactions related to the wager offers in the wager log table.

20. The method of claim 1, wherein the database of wager offers includes:
a category table for all wager offers, the category table having a record of a category type of each individual wager offer thereby allowing searching based upon the category type.

21. The method of claim 1, further comprising:
e) a transaction table that includes records of all transactions for each user.

22. The method of claim 1, wherein the wager payoff offer includes one of money, products, services and points.

23. The method of claim 1, wherein the wager payoff request includes one of money, products, services and points.

24. The method of claim 1, wherein the wager payoff offer is different than the wager payoff request.

25. The method of claim 1, wherein the wager condition is based on a determinative outcome of at least one of a sporting event, a public election, a public event, an entertainment award, the weather at a predetermined time and location, a financial indicator value at a particular time and day, and a specific user defined event.

26. The method of claim 1, further comprising:
e) resolving a dispute over an individual wager offer between an individual wager creator and an individual wager acceptor by requesting that users other than the individual wager creator and the individual wager acceptor electronically case a vote in the posting area to decide the outcome of the individual wager offer.

27. A computer-implemented method of electronically placing wagers between a plurality of users comprising:
a) a service provider hosting a database of wager offers, the service provider providing an electronic posting area for posting wager offers;
b) a plurality of wager creators different than the service provider electronically communicating individual wager offers to the service provider's database of wager offers for storage therein, the wager offers including:
(i) a wager condition having a determinative outcome,
(ii) a wager payoff offer,
(iii) a wager payoff request,
(iv) a start date, and
(v) a close date;
c) placing the individual wager offers in the posting area;
d) allowing a plurality of wager acceptors to electronically communicate with the posting area to view and directly accept individually posted wager offers, between the start date and the close date of the respective individually posted wager offers, without incurring an individual wager offer service charge;
e) determining for a particular wager offer, after the close date and based on the particular determinative outcome of the particular wager offer, whether (i) the creator of the particular wager offer wins, (ii) the acceptor of the particular wager offer wins, (iii) neither the creator or the acceptor of the particular wager offer wins, or (iv) if there is a dispute between the creator and the acceptor of the particular wager offer; and
f) resolving the dispute over the particular wager offer between the creator and the acceptor of the particular wager offer, if one exists, by requesting that users other than the creator and the acceptor of the particular wager offer electronically cast a vote in the posting area to decide the outcome of the particular wager offer.

28. A networked system for electronically placing wagers between a plurality of users comprising:
a) a website having web pages, the website being configured to be accessed by a plurality of users and to permit users to offer wager offers directly to other users without incurring an individual wager service charge; and
b) a database of wager offers placed by some of the plurality of users, the database including:
(i) records of wager terms;
(ii) records of users placing wager offers;
(iii) records of users accepting wager offers; and
(iv) records of wager outcomes.
